(19) United States
(12) Patent Application Publication
(10) Pub. No.: US 2009/0170418 A1
(43) Pub. Date: Jul. 2, 2009

(54) CONTROLLED ENVIRONMENT CABINET

(75) Inventor: Sean Patrick Codling, Bedfordshire (GB)

Correspondence Address: HESLIN ROTHENBERG FARLEY & MESITI PC, 5 COLUMBIA CIRCLE, ALBANY, NY, 12203, US

(73) Assignee: A1 ENVIROSCIENCES LIMITED, Luton, Bedfordshire (GB)

(21) Appl. No.: 12/306,976

(22) PCT Filed: Feb. 23, 2007
(86) PCT No.: PCT/GB2007/000632

§ 371 Date: Jan. 29, 2009

(30) Foreign Application Priority Data
Jul. 4, 2006 (GB) 0613190.8

(51) Int. Cl. B08B 15/02; F24F 11/053

(52) U.S. Cl. 454/66; 454/239

(57) ABSTRACT

A controlled environment cabinet comprises a working chamber made up of clear panels and a stainless steel frame. Two frontal panels may be raised on hinges to access an interior of the chamber. Working armports are provided, closed by a flexible membrane, which is slit such that an operator may pass an arm into the chamber, but the membrane closes around the arm, restricting airflow out of the chamber. An air treatment unit is supplied with air from the chamber by a fan/filter unit. The air treatment unit can raise or lower the temperature and relative humidity of the air, and the fan/filter unit contains a HEPA filter to remove particulates suspended in the air. The treated air is passed back to the chamber. Controls are provided, whereby a desired temperature, humidity and air flow rate or rate of atmosphere exchange within the chamber may be set.

The present invention relates to a test chamber, cabinet or the like within which atmospheric conditions may be controlled. More particularly but not exclusively, it relates to a mobile test cabinet within which air temperature, humidity and/or airflow velocities may selectably be regulated.

It is well known for laboratory facilities to be provided with built-in fume cupboards, fume hoods or the like, which maintain an inward airflow to prevent harmful materials escaping the fume cupboard and possibly affecting persons working on experiments within the fume cupboard. There are also variants in which there is an outward air flow, to protect materials within the fume cupboard from external contamination. Fume cupboards are generally plumbed into building-scale ventilation systems. Bench-top equipment is available, such as gloveboxes, an interior of which may be maintained in complete isolation from its surroundings. Gloveboxes are used to isolate and contain particularly dangerous materials or to store and manipulate sensitive materials under appropriate conditions (e.g. in an oxygen-free atmosphere).

Entire climate-controlled rooms have been built, for example for testing machinery at low temperatures or under high humidity. However, such installations require significant capital expenditure, and a user must be protected from the internal conditions (or vice versa) if he or she needs to enter to work on the equipment. Silicon wafers for electronic chips are made and processed in “clean room” facilities which currently cost hundreds of millions or billions of pounds to construct and equip.

There is thus a need for more economical and versatile apparatus to provide a controlled environment, for example for testing smaller items of equipment where the safety features of much of the above apparatus would not be required. It would also be beneficial if such apparatus could be self-contained and movable to a desired location, only requiring connection to basic services such as water or electrical power.

It is hence an object of the present invention to provide controlled environment apparatus obviating the above problems and providing some or all of the above benefits.

According to the present invention, there is provided transportable controlled environment apparatus comprising working chamber means having atmosphere inflow and outflow means operatively connected to atmosphere conditioning means, said conditioning means comprising controllable atmospheric temperature regulating means, controllable atmospheric humidity regulating means, and means to circulate an atmosphere from the chamber means through the conditioning means and back to the chamber means.

In a preferred embodiment, the atmosphere conditioning means further comprises atmospheric filtration means adapted to remove suspended particulate material.

Advantageously, said filtration means comprises HEPA (High Efficiency Particulate Arrestance) filter means.

Preferably, the working chamber means is provided with access means adapted to permit a user to insert at least one hand to manipulate items within the chamber means.

Advantageously, said access means comprises at least one selectably openable port means located in a wall of the chamber means.

Said port means may be closed by flap means deflectable by passage of a hand or arm through the port means into the chamber means.

Said flap means may be adapted so to contact an arm or hand extending through the port means as to oppose airflow therethrough.

Preferably, the atmospheric conditioning means comprises evaporator means adapted to reduce atmospheric humidity.

Advantageously, the atmospheric conditioning means comprises atmospheric chilling means and atmospheric heating means.

The atmospheric conditioning means may comprise means, such as misting means, to increase atmospheric humidity.

Preferably, the apparatus comprises control means operatively linked to the atmospheric conditioning means whereby a user may select a desired atmospheric temperature and/or humidity level.

Advantageously, the control means is also adapted selectably to control atmospheric flow rates through the working chamber means, and/or a rate of atmospheric recycling (such as a desired number of atmospheric changes per hour).

The apparatus may be provided with sensor means located within the working chamber means, adapted to detect and report temperature, humidity, atmospheric flow and optionally particulate concentration data.

The control means may be adapted to use said data to control the atmospheric conditioning means.

Alarm means may be provided, adapted to operate when a datum such as atmospheric flow deviates beyond preselected limits.

The atmospheric inflow means may be provided with distributor means adapted to produce atmospheric flow substantially throughout an interior of the working chamber means.

The apparatus may be provided with chassis means adapted to support the working chamber means at a predetermined convenient working height and having the atmospheric conditioning means mounted thereto.

The apparatus may be provided with means, such as wheel means, to facilitate transportation thereof.

The present invention will now be more particularly described by way of examples and with reference to the figures of the accompanying drawings, in which:

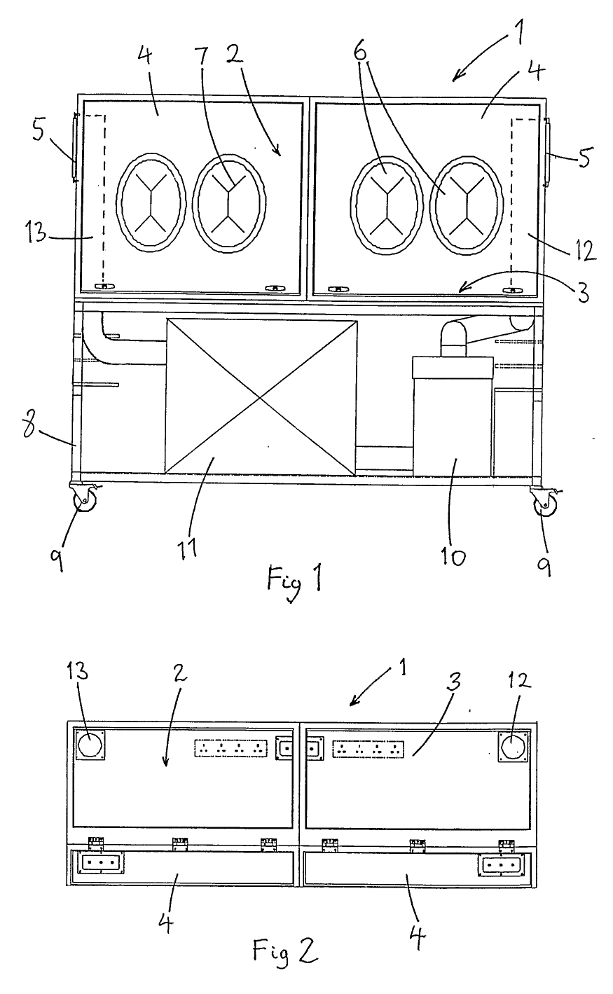

FIG. 1 is a frontal elevation of a first controlled environment cabinet embodying the present invention;

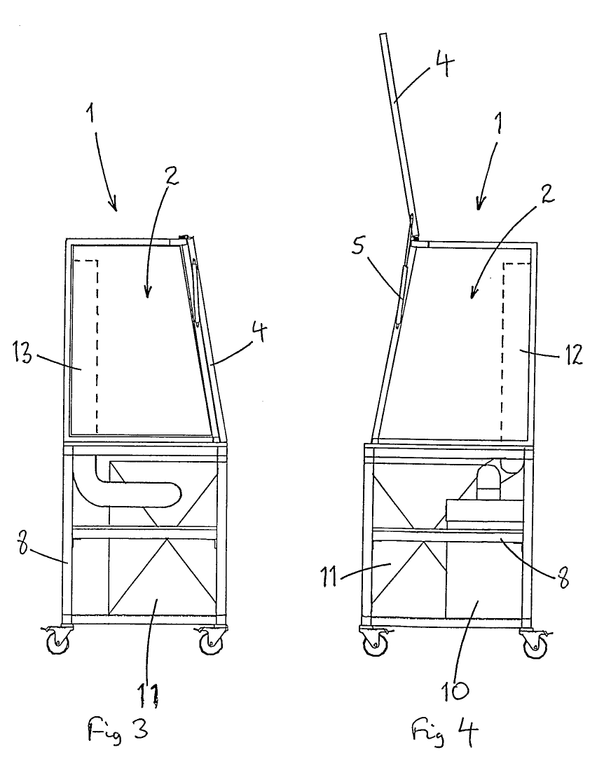

FIG. 2 is a plan view from above of the cabinet shown in FIG. 1;

FIG. 3 is an elevation from a first side of the cabinet shown in FIG. 1;

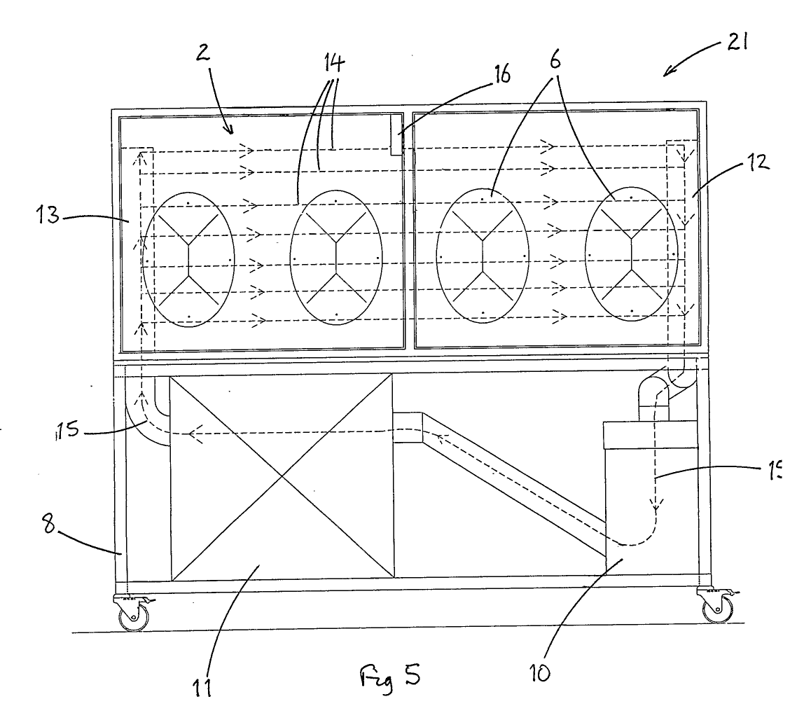

FIG. 4 is an elevation of the cabinet shown in FIG. 1 with its frontal panels open, viewed from a second side opposite the first; and

FIG. 5 is a frontal elevation of a second controlled environment cabinet embodying the present invention, showing airflows therethrough.

Referring now to the Figures and to FIG. 1 in particular, a first controlled environment cabinet 1 comprises a working chamber 2 constructed from clear cast acrylic panels supported by a stainless steel frame. A floor 3 of the chamber 2 comprises a slab of chemical-resistant phenolic resin, which acts as a worktop. The chamber 2 is provided with a pair of hingedly-mounted frontal panels 4, which may independently be raised to allow access to the interior of the chamber 2, each held by a telescopic stay 5 (compare FIGS. 3 and 4).

Each frontal panel 4 is provided with a pair of elliptical armports 6. The armports 6 are each closed by a resiliently flexible polymer membrane having an arrangement of slits 7 formed therein. When a user of the cabinet 1 inserts an arm through an armport 6 into an interior of the working chamber 2, these slits 7 are forced to open to allow the arm to pass. Because of the resilience of the membrane, the flaps formed between the slits 7 remain in contact with the arm. While this does not form a gas-tight seal, it substantially restricts airflow into or out of the chamber 2 through the armports 6, while minimally impeding the actions of the user.

The working chamber 2 is supported at a convenient working height on a stainless steel frame 8, which is provided with lockable wheels 9 to aid transportation of the cabinet 1, or its relocation within a laboratory. Mounted to the frame 8 beneath the working chamber 2 are a fan/filter unit 10 and an air treatment unit 11, which will be described in more detail below.

An exhaust riser 12 extends generally vertically in a first rear corner of the working chamber 2, and is connected to the fan/filter unit 10. This is connected to the air treatment unit 11, which is itself connected in turn to an input riser 13 extending generally vertically in a second rear corner of the chamber 2 remote from the first.

The fan/filter unit 10 contains an electric fan unit, which pulls air from the working chamber 2 through the exhaust riser 12 into the fan/filter unit 10. Within the fan/filter unit 10, this air is passed through a HEPA filter (High Efficiency Particulate Arrestance filter). This is a standard form of filter that removes particles suspended in air, down to a particle size of 0.3 micrometres. (The “book” specification for a HEPA filter is that it must remove at least 99.97% of 0.3 micrometre particles; larger particles are removed even more efficiently, and many HEPA filters can achieve 99.99% removal at 0.3 micrometre). The HEPA filter may be provided with replaceable filters, although it is believed that a three year filter life will be achievable. From the fan/filter unit 10, the filtered air is passed to the air treatment unit 11.

The air treatment unit 11 adjusts the temperature and relative humidity of the air to desired values. The air may be cooled or warmed to a selected temperature within the range +15° C. to +35° C., to an accuracy of ±1° C., at a controlled point. The relative humidity may be controlled to a selected value between 15% RH and 90% RH, to an accuracy of ±3% RH at the controlled point.

To carry out such conditioning, the air treatment unit 11 comprises a conditioning tank, to which air is fed on entering the unit 11, and which contains an evaporator to dry the air, should it have a relative humidity greater than required. The air is then passed through a chiller element, which is operated to cool the air if necessary; alternatively, the chiller element is turned off and a heating element switched on in its place, if the air needs to be heated. If the relative humidity of the air needs to be increased, a water spray unit projects a mist of water over the heating element. The air treatment unit 11 contains a water reservoir for this purpose, which may be manually refillable, or connected to a mains water supply, e.g. via a constant head device.

The conditioned air then passes from the air treatment unit 11 to the input riser 13, which distributes the airflow evenly into the working chamber 2.

FIG. 5 shows the air flow paths thus produced, in a second controlled environment cabinet 21 generally identical to the first cabinet 1 described above. The air flowing from the input riser 13 to the exhaust riser 12 through the working chamber 2 flows smoothly and substantially horizontally as shown by parallel dashed lines 14. It is collected by the exhaust riser 12 before being driven through the fan/filter unit 10 and the air treatment unit 11 back to the input riser 13 (as shown by dashed line 15).

The rate of air flow may be adjusted by changing the speed of the fan unit. The air flow can be adjusted to produce desired air velocities through the working chamber 2 and/or to ensure that a requisite number of complete air changes per hour occurs within the working chamber 2. In either case, the establishment of a directed steady airflow across the working chamber 2 helps to ensure that there is little or no airflow through the armports 6. Thus, even if material is being tested in the chamber 2 that a user should not inhale, it is kept within the cabinet 1 as a whole. Effectively, any excess aerosol material generated within the working chamber 2 will be sucked into the fan/filter unit 10 and taken out of aerial suspension by the HEPA filter.

A sensor unit 16 is shown mounted within the working chamber 2 (a similar unit would be present in the cabinet 1 shown in FIGS. 1 to 4, but is omitted therefrom for simplicity). The sensor unit 16 comprises a thermocouple temperature sensor (e.g. a Pt100 temperature sensor) and a capacitive humidity sensor. The sensor unit 16 is connected to a control system within or linked to the air treatment unit 11, which uses the data from the sensor unit 16 to control the operation of its components to achieve a preselected air temperature and relative humidity. Conveniently, the control system comprises a programmable logic controller (PLC) linked to relays controlling each component of the air treatment unit 11.

The sensor unit 16 is shown in a generally central position, where it should collect substantially representative data on the air in the working chamber 2. Optionally, the sensor unit 16 may be relocatable to a preferred position within the chamber 2, and/or further sensor units 16 may be provided in other positions within the chamber 2.

A hot wire anemometer is used to measure air flow speeds. This is located in the exhaust riser 12, and is provided with its own display unit, including an alarm which is sounded, should the air flow leave permissible limits. The air flow may be adjusted by means of manual controls on the fan/filter unit 10.

A control panel is provided to allow selection of a desired temperature and relative humidity, and to display current sensor data thereon. This may be positioned at any convenient point on or adjacent the cabinet 1, 21, so has been omitted from the Figures for simplicity. As well as desired target values, the control panel may be used to adjust the permissible limits within which air temperature, etc, may vary. Warning lights are provided to alert a user should the temperature, etc, leave these permissible limits.

If desired, independent data logger sensors may be positioned within the working chamber 2, preferably on gooseneck mounts so that each data logger sensor may be positioned at a desired point. A data logger arrangement of conventional form may be used to collect the data from these sensors.

The control panel also includes warning lights and/or other alarms to alert a user to faults, including high or low water levels in the water tank in the air treatment unit 11 or a PLC fault in the control system.

The form of the invention shown is of particular use in testing pharmaceutical materials and apparatus, such as inhalers for asthma medications. These inhalers are designed to produce an aerosol dispersion of droplets of a solution of the medication (or of powdered solid medication). It is critical to their effectiveness that they reliably produce the correct droplet concentration and droplet size distributions. The production and stability of aerosols depend greatly on the temperature and relative humidity of the ambient atmosphere. Also, when one is measuring aerosol droplet sizes and concentrations, the background level of airborne particulates in the same general size range should be as low as possible. In some cases, adventitious airborne particulates might even influence nucleation and coalescence of droplets.

Testing of such inhalers is thus best carried out under controlled temperature and humidity, ideally over a range of set temperatures and humidity levels, and with the air in the vicinity being as clear of extraneous particulates as possible. The apparatus of the present invention thus provides an excellent test cabinet for this purpose. The medications themselves are not particularly harmful, so do not need strict isolation measures to keep them away from a user of the cabinet. Nevertheless, since they are pharmacologically active, some precautions are necessary. The air circulation established through the working chamber 2, together with the minimal gaps between the membranes of the armports 6 and a user's arms, ensures that there is practically no airflow towards the user. Meanwhile, any aerosol dispersions of medication formed in the chamber 2 will be intercepted as soon as the air is passed through the HEPA filter, where they can affect neither the user nor the results of subsequent experiments.

This almost closed system produces an additional benefit, in that once the recycled air in the cabinet 1, 21 is conditioned to a desired temperature and humidity, it is easy to maintain at those levels, unlike some systems in which a fresh intake of air must continually be conditioned.

The cabinets 1, 21 are also useful in other powder handling work, in which the flow behaviour of powders may be critically dependent on ambient humidity, for example.

The self-contained and mobile construction of the cabinets 1, 21 mean that they can easily and conveniently be installed wherever required, without needing engineering work to connect them to building extraction systems. No more than a conventional mains electric connection is needed (and possibly a mains water connection in some versions).

1. Transportable controlled environment apparatus comprising a working chamber provided with atmosphere inflow means, atmosphere outflow means, and atmosphere conditioning means operatively connected to said atmosphere inflow means and said atmosphere outflow means, wherein said atmosphere conditioning means comprises controllable atmospheric temperature regulating means, controllable atmospheric humidity regulating means and means to circulate an atmosphere from the working chamber through the atmosphere conditioning means and back to the working chambers.

2. Apparatus as claimed in claim 1, wherein the atmosphere conditioning means further comprises atmospheric filtration means adapted to remove suspended particulate material.

3. Apparatus as claimed in claim 2, wherein said filtration means comprises HEPA (High Efficiency Particulate Arrestance) filter means.

4. Apparatus as claimed in claim 1, wherein the working chamber includes access means adapted to permit a user to insert at least one hand to manipulate items within the working chamber.

5. Apparatus as claimed in claim 4, wherein said access means comprises at least one selectably openable port located in a wall of the chamber means.

6. Apparatus as claimed in claim 5, wherein each said selectably openable port is closed by a flap or flaps deflectable by passage of a hand or arm through the selectably openable port means into the working chamber.

7. Apparatus as claimed in claim 1, wherein the atmospheric conditioning means comprises an evaporator adapted to reduce atmospheric humidity.

8. Apparatus as claimed in claim 1, wherein the atmospheric conditioning means comprises means to increase atmospheric humidity.

9. Apparatus as claimed in claim 1, wherein the atmospheric conditioning means comprises atmospheric chilling means and atmospheric heating means.

10. Apparatus as claimed in claim 1 further comprising control means operatively linked to the atmospheric conditioning means such that a user may select one or both of desired atmospheric temperature and desired atmospheric humidity level.

11. Apparatus as claimed in claim 10, wherein the control means is adapted selectably to control at least one of atmospheric flow rates through the working chamber and a rate of atmospheric recycling.

12. Apparatus as claimed in claim 1, further comprising sensors located within the working chamber adapted to detect and report temperature, humidity, atmospheric flow and optionally particulate concentration data.

13. Apparatus as claimed in claim 12, further comprising alarm means adapted to operate when a datum reported by said sensors deviates beyond preselected limits.

14. Apparatus as claimed in claim 1, wherein the atmospheric inflow means includes a distributor adapted to produce atmospheric flow substantially throughout an interior of the working chamber.

15. Apparatus as claimed in claim 1, further comprising wheels, to facilitate transportation of the apparatus.

16. Apparatus as claimed in claim 6, wherein said flap or flaps are adapted so as to contact an arm or hand extending through the selectably openable port as to oppose airflow through the port.

17. Apparatus as claimed in claim 8, wherein the atmospheric conditioning means comprises misting means.
